(19) United States
(12) Patent Application Publication
(10) Pub. No.: US 2018/0151981 A1
(43) Pub. Date: May 31, 2018

(54) CONNECTOR

(71) Applicant: TOYOTA JIDOSHA KABUSHIKI KAISHA, Toyota-shi (JP)

(72) Inventors: Kenji UMEMURA, Toyota-shi (JP); Koichi YOKOTANI, Toyota-shi (JP)

(73) Assignee: TOYOTA JIDOSHA KABUSHIKI KAISHA, Toyota-shi (JP)

(21) Appl. No.: 15/800,843

(22) Filed: Nov. 1, 2017

(30) Foreign Application Priority Data
Nov. 29, 2016 (JP) 2016-231026

(51) Int. Cl. H01R 13/629; B60R 16/02

(52) U.S. Cl. CPC H01R 13/629; H01R 2201/26; B60R 16/02

(57) ABSTRACT

A connector is provided with a connector body, a plurality of terminals, and a pair of protective walls. The connector body includes an opening portion facing a connector attachment port of electrical equipment when the connector is attached to the connector attachment port. The terminals are fixed to the connector body such that the terminals are aligned in a row in the opening portion. Tips of the terminals protrude from the opening portion. The protective walls are disposed on both sides of the connector in an alignment direction in which the terminals are aligned. The protective walls overlap with parts of the terminals protruding from the opening portion when seen from the alignment direction of the terminals.

### INCORPORATION BY REFERENCE

The disclosure of Japanese Patent Application No. 2016-231026 filed on Nov. 29, 2016 including the specification, drawings and abstract is incorporated herein by reference in its entirety.

### BACKGROUND

### 1. Technical Field

The disclosure relates to a connector connected to electrical equipment mounted in a car.

### 2. Description of Related Art

Various types of electrical equipment are mounted in a car. Two of the electrical equipment are connected by a cable. A connector is provided at the tip of the cable and the connector is attached to the casing of the electrical equipment. Japanese Unexamined Patent Application Publication No. 2016-131481 (JP 2016-131481 A) discloses a connector attached to an inverter of an electric car. The connector connects to the inverter a power cable transmitting three-phase alternating-current electric power to two motors. The connector has six terminals. The six terminals transmit two sets of three-phase alternating current. The six terminals are fixed to a connector body such that the six terminals line up in a row in an opening portion facing a connector attachment port of the inverter when the connector is attached to the connector attachment port. The six terminals have tips protruding from the opening portion.

### SUMMARY

With the terminals protruding from the opening portion of the connector body, the terminals may be deformed by coming into contact with the electrical equipment when the connector is attached to the connector attachment port of the electrical equipment. A technique is desired so that the parts of the terminals that protrude from the opening portion can be protected with the terminals lining up in a row.

An aspect relates to a connector including a connector body, a plurality of terminals, and a pair of protective walls. The connector body includes an opening portion facing a connector attachment port of electrical equipment when the connector is attached to the connector attachment port. The terminals are fixed to the connector body such that the terminals are aligned in a row in the opening portion. Tips of the terminals protrude from the opening portion. The protective walls are disposed on both sides of the connector body in an alignment direction in which the terminals are aligned, and the protective walls overlap with parts of the terminals protruding from the opening portion when seen from the alignment direction of the terminals. The protective walls protect the parts of the terminals that protrude from the opening portion from coming into contact with a casing of the electrical equipment.

In the connector of the aspect, each of the protective walls may protrude from the opening portion with a length longer than a length by which the terminals protrude from the opening portion when seen from the alignment direction of the terminals. The protective walls, as described above, are capable of more reliably protecting the parts of the terminals protruding from the opening portion.

In the connector of the aspect, a tip of each of the protective walls may be tapered when seen from the alignment direction of the terminals. When the connector is attached to the connector attachment port on the electrical equipment side, the connector is smoothly fitted by the protective walls acting as a guide.

In the connector of the aspect, the connector may be attached to a side surface of the electrical equipment facing a horizontal direction with the alignment direction being the horizontal direction. The tip is positioned an edge of a lower part of each of protective walls when the connector is connected to the electrical equipment. The tip is inclined upward toward the electrical equipment when seen from the alignment direction of the terminals. During the attachment to the electrical equipment, the connector tends to fall due to gravity. Accordingly, lower sides of the protective walls are likely to come into contact with the electrical equipment. As a result of the upward inclination of the tips of the edges on the lower sides of the protective walls toward the electrical equipment, smooth attachment to the connector attachment port on the electrical equipment side can be performed despite the tendency of the connector to fall.

Details of and further improvements on the technique that is disclosed in the present specification will be described in the following “DETAILED DESCRIPTION OF EMBODIMENTS”.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a front view of a connector according to an example;

FIG. 2 is a cross-sectional view taken along line II-II of FIG. 1;

FIG. 3 is a cross-sectional view taken along line III-III of FIG. 1;

FIG. 4 is a perspective view of the vicinity of one protective wall of the connector;

FIG. 5 is a diagram illustrating how a connector according to a comparative example is attached to a connector attachment port when the connector according to the comparative example is attached to the connector attachment port; and

FIG. 6 is a diagram illustrating how the connector according to the example is attached to a connector attachment port when the connector according to the example is attached to the connector attachment port.

### DETAILED DESCRIPTION OF EMBODIMENTS

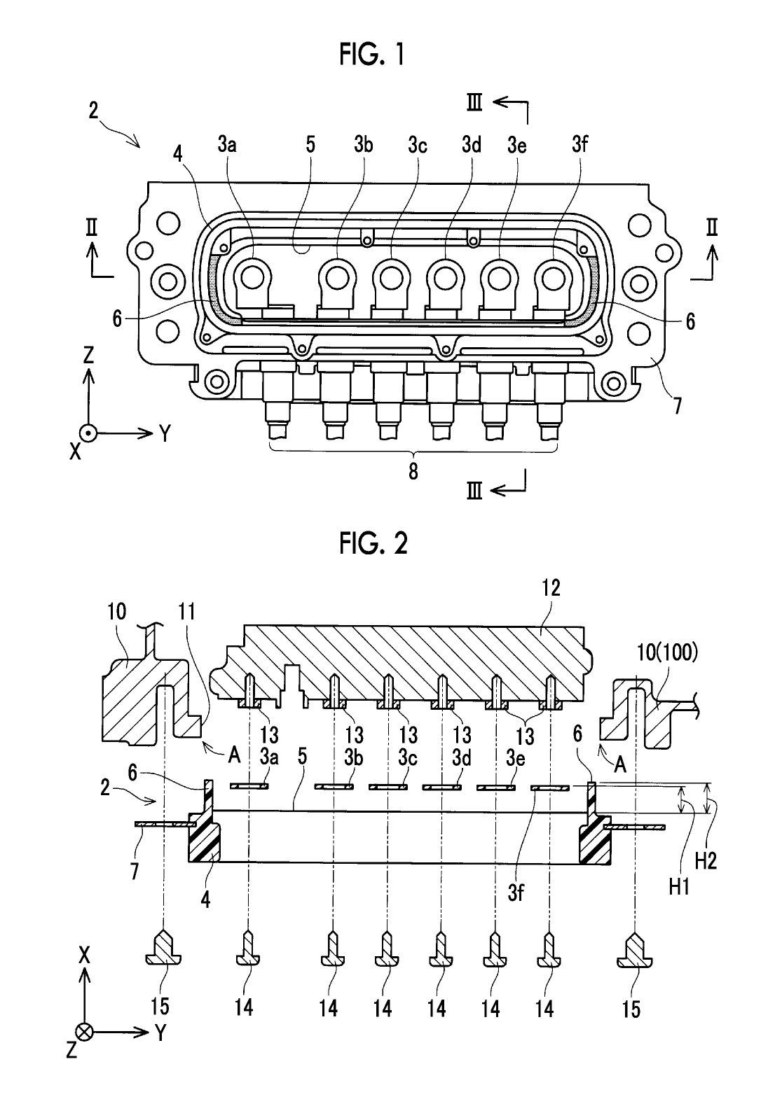

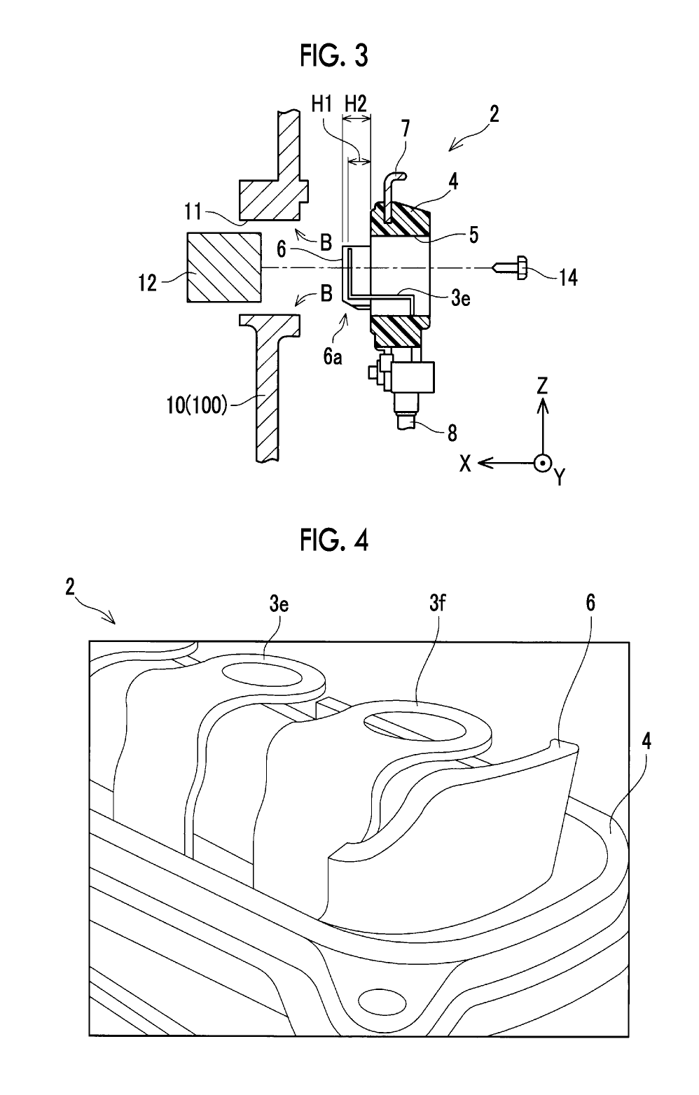

A connector 2 according to an example will be described with reference to accompanying drawings. FIG. 1 is a front view of the connector 2. FIG. 2 is a cross-sectional view taken along line II-II of FIG. 1. FIG. 3 is a cross-sectional view taken along line III-III of FIG. 1. Also illustrated in FIGS. 2 and 3 is a cross section of a part of a casing 10 of an inverter 100 as a destination of connection of the connector 2. The connector 2 is a component that is used for connecting six cables 8 to the inverter 100 mounted in an electric car. The cables 8 are electric power cables that are used for transmitting two sets of three-phase alternating-current electric power output by the inverter 100 to two motors, respectively.

The connector 2 is connected to connector attachment ports 11 (refer to FIGS. 2 and 3) disposed in the casing 10 of the inverter 100. The connector 2 is provided with a resinous connector body 4 and six terminals 3a to 3f. In FIG. 3, the terminals 3a to 3e overlap with one another without exception. The six terminals 3a to 3f are fixed to the connector body 4. The six terminals 3a to 3f are connected to the respective corresponding cables 8 in the connector body 4.

The connector body 4 has an opening portion 5, which faces the connector attachment port 11 when the connector 2 is attached to the connector attachment port 11 of the inverter 100. The six terminals 3a to 3f are disposed to line up in a row inside the opening portion 5 in plan view of the opening portion 5 of the connector 2. The Y direction of the coordinate system in the drawings corresponds to the direction in which the terminals 3a to 3f are aligned. The six terminals 3a to 3f protrude by a length H1 from the opening portion 5 (refer to FIGS. 2 and 3).

A pair of protective walls 6 is disposed at edges of the opening portion 5. For ease of understanding, the protective walls 6 are shown in gray in FIG. 1. The protective walls 6 are disposed on both sides of the terminals 3a to 3f in the alignment direction of the six terminals 3a to 3f (Y direction in the drawings). The protective walls 6 protrude by a length H2 from the opening portion 5 (refer to FIGS. 2 and 3). The protrusion length H2 of the protective walls 6 is longer than the protrusion length H1 of the terminals 3a to 3f. In other words, the protective walls 6 extend from the opening portion 5 with a length longer than the length by which the terminals 3a to 3f protrude from the opening portion 5. As illustrated in FIG. 3, the protective walls 6 overlap with the parts of the terminals 3a to 3f that protrude from the opening portion 5 when seen from the Y direction of the coordinate system in the drawing, that is, the alignment direction of the terminals 3a to 3f. In other words, the protective walls 6 cover the parts of the terminals 3a to 3f that protrude from the opening portion 5 when seen from the alignment direction of the terminals 3a to 3f. The protective walls 6 have the same shape. Accordingly, the protective wall that is on the far side of the page in FIG. 3 covers the parts of the terminals 3a to 3f that protrude from the opening portion 5 when seen from the alignment direction of the terminals 3a to 3f as is the case with the protective wall 6 that is illustrated in FIG. 3. The protective walls 6 and the connector body 4 are resinous. The protective walls 6 are made integrally with the connector body 4 by injection molding of a resin. FIG. 4 is a perspective view of the vicinity of the one protective wall 6.

A metal plate 7 spreads around the connector body 4. As illustrated in FIG. 2, the metal plate 7 is fixed to the casing 10 of the inverter 100 by bolts 15. A terminal block 12 is disposed inside the connector attachment ports 11 of the casing 10. Busbars 13 are fixed to the terminal block 12. The busbars 13 are electrically connected to the terminals 3a to 3f, respectively. The respective busbars 13 and the terminals 3a to 3f are electrically connected to each other by the terminals 3a to 3f being tightened together with the respective corresponding busbars 13 by bolts 14.

As illustrated in FIGS. 2 and 3, the protective walls 6 prevent the parts of the terminals 3a to 3f that protrude from the opening portion 5 from coming into contact with opening edges of the connector attachment ports 11 of the casing 10 (places shown by sign A in FIG. 2 and shown by sign B in FIG. 3) when the connector 2 is attached to the casing 10. As illustrated in FIG. 3, the protective walls 6 cover the entire parts of the terminals 3a to 3f that protrude from the opening portion 5 when seen from the alignment direction of the terminals 3a to 3f. Accordingly, contact of the terminals 3a to 3f with the connector attachment port 11 is prevented by the protective walls 6 abutting against the connector attachment port 11. The protective walls 6 protect the terminals 3a to 3f from deformation attributable to contact of the terminals 3a to 3f with the connector attachment port 11 during the attachment of the connector 2.

As illustrated in FIG. 3, the protective walls 6 are tapered toward tips with edges 6a beneath the tips in FIG. 3 chamfered. In other words, the tips of the protective walls 6 are tapered when seen from the alignment direction of the terminals 3a to 3f.

The casing 10 of the inverter 100 is mounted in the car such that the forward direction of the Z direction in the coordinate system in the drawings faces upward. The connector attachment port 11 is disposed on a side surface of the casing 10 that faces the horizontal direction. The connector 2 is attached to the connector attachment port 11 with the alignment direction of the terminals 3a to 3f being the horizontal direction. Accordingly, when the connector 2 is connected to the inverter 100 in the car, the tips of the edges 6a of the protective walls 6 positioned below the inverter 100 side are inclined upward toward the inverter 100. When the connector 2 is attached, the connector 2 is likely to be shifted downward from the connector attachment port 11 by gravity. As a result of the inclination of the edges 6a beneath the tips of the protective walls 6, tip surfaces of the protective walls 6 are less likely to hit the opening edges of the connector attachment ports 11 when the connector 2 is attached to the connector attachment ports 11.

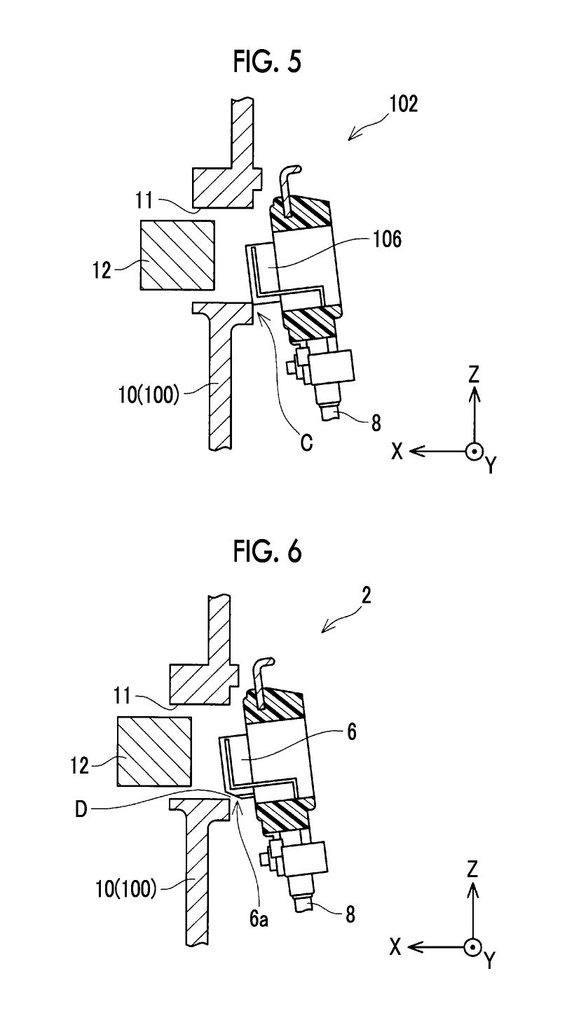

FIG. 5 is a diagram illustrating how a connector 102 that does not have the inclined edge 6a is attached to the connector attachment port 11 of the casing 10 when the connector 102 is attached to the connector attachment port 11. Once the position of the connector 102 is shifted downward from the connector attachment port 11, a tip of a protective wall 106 may abut against the opening edge of the connector attachment port 11 as in the place shown by sign C and connection work for the connector 102 may become complicated.

FIG. 6 is a diagram illustrating how the connector 2 according to the example is attached to the connector attachment port 11 when the connector 2 according to the example is attached to the connector attachment port 11. The slope of the connector 2 according to FIG. 6 is equal to the slope of the connector 102 according to FIG. 5. When the edges 6a of the lower tips of the protective walls 6 are inclined upward toward the inverter 100 as illustrated in FIG. 6, the likelihood of contact between the tip surfaces of the protective walls 6 and the opening edges of the connector attachment ports 11 can be reduced (refer to the place shown by sign D in FIG. 6). In addition, the connector 2 can be smoothly inserted between the connector attachment ports 11 by the edges 6a inclined upward toward the inverter 100 acting as a guide.

As described above, the connector 2 according to the example is provided with the protective walls 6 covering the entire parts of the terminals 3a to 3f that protrude from the opening portion 5 when seen from the alignment direction of the terminals 3a to 3f. The protective walls 6 prevent deformation of the terminals 3a to 3f attributable to contact of the terminals 3a to 3f with the connector attachment port 11 during the attachment of the connector 2 to the connector attachment port 11 of the casing 10 of the inverter 100.

The protective walls 6 are tapered when seen from the alignment direction of the terminals 3a to 3f. The tapered structure facilitates the attachment of the connector 2 to the connector attachment port 11. In particular, the edges 6a of the protective walls 6, which are lower sides during the attachment to the connector attachment port 11, are inclined upward toward the inverter 100. The structure reduces the likelihood of contact between the connector attachment port 11 and the tip surfaces of the protective walls 6 of the connector 2, which tends to be biased downward by gravity.

Points to be noted with regard to the description of the example will be described below. The protective walls 6 according to the example protrude from the opening portion 5 with a length longer than the length by which the terminals 3a to 3f protrude from the opening portion 5 when seen from the alignment direction of the terminals 3a to 3f. The protrusion length of the protective walls 6 from the opening portion 5 (length H2 in FIGS. 2 and 3) may also be equal to the protrusion length of the terminals 3a to 3f from the opening portion 5 (length H1 in FIGS. 2 and 3). Nevertheless, the terminals 3a to 3f can be more reliably protected when the protective walls 6 protrude from the opening portion 5 with a length longer than the length by which the terminals 3a to 3f protrude from the opening portion 5. The inverter 100 according to the example is an example of electrical equipment. The technique that is disclosed in the present specification can also be applied to a connector connected to an in-vehicle device other than an inverter. The number of the terminals of the connector is not limited to six.

A specific example has been described in detail above. The specific example is merely an example and does not limit the scope of claims. The technique that is described in the scope of claims includes various modifications and changes based on the specific example that has been described above. The technical elements that have been described and illustrated in the present specification and the drawings demonstrate technical usefulness either alone or in various combinations, and are not limited to the combinations described in the claims at the time of filing. The technique exemplified in the present specification and illustrated in the drawings is capable of simultaneously achieving the effects described in the “SUMMARY” and maintains its technical usefulness even if merely one of the effects is achievable.

What is claimed is:

1. A connector connected to electrical equipment mounted in a car, the connector comprising:
a connector body including an opening portion facing a connector attachment port of the electrical equipment when the connector is attached to the connector attachment port;
a plurality of terminals fixed to the connector body such that the terminals are aligned in a row in the opening portion, tips of the terminals protruding from the opening portion; and
a pair of protective walls, the protective walls being disposed on both sides of the connector body in an alignment direction in which the terminals are aligned, and the protective walls overlapping with parts of the terminals protruding from the opening portion when seen from the alignment direction of the terminals.

2. The connector according to claim 1, wherein each of the protective walls protrudes from the opening portion with a length longer than a length by which the terminals protrude from the opening portion when seen from the alignment direction of the terminals.

3. The connector according to claim 1, wherein a tip of each of the protective walls is tapered when seen from the alignment direction of the terminals.

4. The connector according to claim 3, wherein:
the connector is attached to a side surface of the electrical equipment facing a horizontal direction with the alignment direction being the horizontal direction; and
the tip is positioned an edge of a lower part of each of protective walls when the connector is connected to the electrical equipment, and the tip is inclined upward toward the electrical equipment when seen from the alignment direction of the terminals.
